(19) United States
(12) Patent Application Publication
(10) Pub. No.: US 2025/0313126 A1
(43) Pub. Date: Oct. 9, 2025

(54) METHOD OF MANAGING THE SUPPLY OF ELECTRICAL ENERGY IN A VEHICLE, CONTROL ARRANGEMENT, AND VEHICLE

(71) Applicant: Scania CV AB, Södertälje (SE)

(72) Inventors: Samer SHISHA, Järfälla (SE); Christer ROOS, Rönninge (SE); Johan LINDSTRÖM, Stockholm (SE)

(73) Assignee: Scania CV AB, Södertälje (SE)

(21) Appl. No.: 18/872,922

(22) PCT Filed: May 26, 2023
(86) PCT No.: PCT/SE2023/050516

§ 371 Date: Dec. 9, 2024

(30) Foreign Application Priority Data
Jun. 29, 2022 (SE) 2250801-4

(51) Int. Cl. B60L 58/18; B60L 58/12; H02J 7/00

(52) U.S. Cl. CPC B60L 58/18; B60L 58/12; H02J 7/0068; B60L 2200/36; B60L 2210/10; B60L 2240/545; B60L 2240/547

(57) ABSTRACT

A method of managing the supply of electrical energy in a vehicle is disclosed. The vehicle comprises an electric propulsion system, a rechargeable energy storage system configured to provide electricity to the electric propulsion system during operation of the vehicle, a number of electric components, and an electrical connector for the connection to an external electric power source. The method comprises the steps of charging a first set of segments of the rechargeable energy storage system using electricity from the external electric power source and connecting a second set of segments of the rechargeable energy storage system to at least one electric component. The present disclosure further relates to a computer program, a computer-readable medium, a control arrangement, and a vehicle.

### TECHNICAL FIELD

The present disclosure relates to method of managing the supply of electrical energy in a vehicle. The present disclosure further relates to a computer program, a computer-readable medium, a control arrangement, and a vehicle

### BACKGROUND

The use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

An at least partially electric vehicle comprises a rechargeable energy storage system configured to provide electricity to the electric propulsion system during operation of the vehicle. Typically, the rechargeable energy storage system comprises a number of battery packs each comprising a number of rechargeable battery cells. Some different types of battery cells are used, such as lithium-ion battery cells, lithium polymer battery cells, as well as other types of rechargeable battery cells. A large number of battery cells is normally needed to ensure a sufficient available operational range of a vehicle, system voltage and power, especially in heavier types of pure electric vehicles.

In many cases, a rechargeable energy storage system of a vehicle comprises a number of segments coupled in parallel to the electric propulsion system during use of the vehicle. Each of such segments typically comprise one or more battery packs. Especially in heavier vehicles, each of such segments normally comprise a large number of battery cells to obtain a sufficient system voltage and power.

The rechargeable energy storage system is normally recharged using a charging module which supplies a direct current to the rechargeable energy storage system at a certain charging voltage. A high charging voltage is normally needed to charge the rechargeable energy storage system of a vehicle due to the size of different segments of the rechargeable energy storage system.

Electromagnetic interference, usually abbreviated EMI, is a challenge for the vehicle industry. Electromagnetic interference EMI can be defined as the degradation in the performance of a device, equipment, or system caused by an electromagnetic disturbance. Electromagnetic disturbance can be defined as an electromagnetic phenomenon that can degrade the performance of a device, equipment, or system. The terms “electromagnetic disturbance” and “electromagnetic interference” thus designate respectively the cause and the effect.

Electromagnetic compatibility, usually abbreviated EMC, is the ability of electrical equipment and systems to function acceptably in their electromagnetic environment. In other words, electromagnetic compatibility EMC is an equipment characteristic or property and can be defined as the ability of equipment or a system to function satisfactorily in its electromagnetic environment without introducing intolerable electromagnetic disturbances to anything in that environment. Accordingly, electromagnetic compatibility EMC is the control of the electromagnetic interference EMI so that unwanted effects are prevented.

In the vehicle industry, issues with electromagnetic compatibility EMC are in many cases alleviated by increasing the Y-capacitances of the electrical system. Capacitance is a measure of the ability to store electrical charge of a component or system. In isolated DC systems of vehicles, a distinction is made between X-capacitance and Y-capacitance, where X-capacitance can be defined as the capacitance between DC conductors and Y-capacitance can be defined as the capacitance between DC conductors and ground. Capacitance can be a desired property, for example when using a number of capacitors, but can also be an undesirable property of an electrical circuit.

In switched systems, Y-capacitors can be used to suppress electromagnetic interference EMI and radio frequency interference RFI. A higher magnitude of the capacitance of the Y-capacitors is usually selected in systems which switches higher electrical currents, and vice versa.

Due to the high charging voltage and currents during charging of a rechargeable energy storage system of a vehicle, a high Y-capacitance of the charging circuit is normally needed to reduce the electromagnetic interference EMI. However, partly because of safety reasons, the Y-capacitance of a system can be subjected to limitations set by charging standards.

Moreover, many vehicles can comprise various systems and arrangements powered via the rechargeable energy storage system of the vehicle, such as for example an electric power take-off unit, an inverter, a climatization component, or the like.

On some occasions, it may be wanted to operate one or more of such systems and/or arrangements during charging of the rechargeable energy storage system of the vehicle, which adds to the problems of the limitations on the electromagnetic interference EMI and Y-capacitances. This is because the powering of the such systems and/or arrangements increases the electromagnetic disturbance and more systems and/or arrangements usually means more Y-capacitances and/or an increased electromagnetic interference EMI which causes a reduced electromagnetic compatibility EMC.

The requirements on Y-capacitance and electromagnetic interference EMI are more strictly limited for vehicles while charging. Therefore, it may be desired to reduce the use of additional systems and/or arrangements during charging of the rechargeable energy storage system of a vehicle. However, this may conflict with the interests of the customers who might want to have their equipment running while charging.

Y-capacitance values are also related to large components and systems, such as rechargeable energy storage systems of vehicles. Hence the limitations on the Y-capacitance values can directly impact the design of the rechargeable energy storage system and the installed energy storing capacity thereof.

### SUMMARY

It is an object of the present invention to overcome, or at least alleviate, at least some of the above-mentioned problems and drawbacks.

According to a first aspect of the invention, the object is achieved by a method of managing the supply of electrical energy in a vehicle, wherein the vehicle comprises:
an electric propulsion system for providing motive power to the vehicle,
a rechargeable energy storage system configured to provide electricity to the electric propulsion system during operation of the vehicle,
a number of electric components, and
an electrical connector for the connection to an external electric power source,
   wherein the method comprises the steps of:
charging a first set of segments of the rechargeable energy storage system using electricity from the external electric power source, and
connecting a second set of segments of the rechargeable energy storage system to at least one electric component, wherein the second set of segments of the rechargeable energy storage system is separate from the first set of segments.

Since the method comprises the steps of charging the first set of segments of the rechargeable energy storage system using electricity from the external electric power source, and connecting the second set of segments of the rechargeable energy storage system to at least one electric component, conditions are provided for charging the rechargeable energy storage system while operating the at least one electric component without exceeding limitations on Y-capacitance and electromagnetic interference EMI for example set by charging standards.

This is because the electromagnetic interference EMI is reduced by only charging the first set of segments of the rechargeable energy storage system while the second set of segments can be used to power the at least one electric component. That is, the electromagnetic interference EMI can be reduced since the at least one electric component can be powered separately from the external electric power source and the external electric power source will thereby not be exposed to the electromagnetic interference EMI from the powering of the least one electric component. Moreover, the electromagnetic interference EMI can be reduced because only the first set of segments of the rechargeable energy storage system is charged using electricity from the external electric power source.

As a further result, the method provides conditions for arranging one or more additional segments to the rechargeable energy storage system of the vehicle without exceeding limitations on Y-capacitance and electromagnetic interference EMI during charging of the rechargeable energy storage system. In other words, the method provides conditions for using a high number of segments for the rechargeable energy storage system, which can increase the energy storage capacity of the rechargeable energy storage system, without exceeding limitations on Y-capacitance and electromagnetic interference EMI for example set by charging standards. Moreover, the method provides conditions for increasing the capability to run several electric components without exceeding limitations on Y-capacitance and electromagnetic interference EMI.

Accordingly, a method is provided overcoming, or at least alleviating, at least some of the above-mentioned problems and drawbacks. As a result, the above-mentioned object is achieved.

Optionally, the step of charging the first set of segments of the rechargeable energy storage system is performed during a first time period, and wherein the method comprises the step of, at the end of the first time period,
performing a switch such that the second set of segments of the rechargeable energy storage system is charged using electricity from the external electric power source and such that the first set of segments of the rechargeable energy storage system is connected to the at least one electric component.

In this manner, it can be ensured that the full rechargeable energy storage system can be charged to a desired state of charge level, while being capable of operating the at least one electric component of the vehicle using electricity from the rechargeable energy storage system, without exceeding limitations on Y-capacitance and electromagnetic interference EMI.

Optionally, the method comprises the step of:
monitoring data representative of at least one of a state of charge level, a voltage level, and a temperature of at least one of the first and second sets of segments of the rechargeable energy storage system, and
setting a duration of the first time period based on the monitored data.

Thereby, the full rechargeable energy storage system can be charged in a safe, reliable, and efficient manner to a desired state of charge level, while being able to operate the at least one electric component of the vehicle using electricity from the rechargeable energy storage system, without exceeding limitations on Y-capacitance and electromagnetic interference EMI.

Optionally, the method comprises the steps of, prior to the step of charging the first set of segments using electricity from the external electric power source and the step of connecting the second set of segments to the at least one electric component,
determining a state of charge level of different segments of rechargeable energy storage system, and
setting the first and second sets of segments to comprise different segments of the rechargeable energy storage system based on the determined state of charge level of the different segments of the rechargeable energy storage system.

Thereby, conditions are provided for an efficient utilization of the segments of the rechargeable energy storage system based on the state of charge level thereof.

Optionally, the step of setting the first and second sets of segments comprises the step of:
setting the first and second sets of segments such that the first set of segments comprises one or more segments each having a lower state of charge level than segments comprised in the second set of segments.

Thereby, conditions are provided for an efficient utilization of the segments of the rechargeable energy storage system while it is ensured that the segments having a lower state of charge level are charged at least initially.

According to a second aspect of the invention, the object is achieved by a computer program comprising instructions which, when the program is executed by a computer, cause the computer to carry out the method according to some embodiments of the present disclosure. Since the computer program comprises instructions which, when the program is executed by a computer, cause the computer to carry out the method according to some embodiments, a computer program is provided which provides conditions for overcoming, or at least alleviating, at least some of the above-mentioned drawbacks. As a result, the above-mentioned object is achieved.

According to a third aspect of the invention, the object is achieved by a computer-readable medium comprising instructions which, when executed by a computer, cause the computer to carry out the method according to some embodiments of the present disclosure. Since the computer-readable medium comprises instructions which, when the program is executed by a computer, cause the computer to carry out the method according to some embodiments, a computer-readable medium is provided which provides conditions for overcoming, or at least alleviating, at least some of the above-mentioned drawbacks. As a result, the above-mentioned object is achieved.

According to a fourth aspect of the invention, the object is achieved by a control arrangement configured to manage the supply of electrical energy in a vehicle, wherein the vehicle comprises:
an electric propulsion system for providing motive power to the vehicle,
a rechargeable energy storage system configured to provide electricity to the electric propulsion system during operation of the vehicle,
a number of electric components, and
an electrical connector for the connection to an external electric power source,
   wherein the control arrangement is configured to:
charge a first set of segments of the rechargeable energy storage system using electricity from the external electric power source, and
connect a second set of segments of the rechargeable energy storage system to at least one electric component, wherein the second set of segments of the rechargeable energy storage system is separate from the first set of segments.

Since the control arrangement is configured to charge the first set of segments of the rechargeable energy storage system using electricity from the external electric power source, and connect the second set of segments of the rechargeable energy storage system to at least one electric component, conditions are provided for charging the rechargeable energy storage system while operating the at least one electric component without exceeding limitations on Y-capacitance and electromagnetic interference EMI for example set by charging standards.

This is because the electromagnetic interference EMI is reduced by only charging the first set of segments of the rechargeable energy storage system while the second set of segments can be used to power the at least one electric component. That is, the electromagnetic interference EMI can be reduced since the at least one electric component can be powered separately from the external electric power source and the external electric power source will thereby not be exposed to the electromagnetic interference EMI from the powering of the least one electric component. Moreover, the electromagnetic interference EMI can be reduced because only the first set of segments of the rechargeable energy storage system is charged using electricity from the external electric power source.

As a further result, the control arrangement provides conditions for arranging one or more additional segments to the rechargeable energy storage system of the vehicle without exceeding limitations on Y-capacitance and electromagnetic interference EMI. In other words, the control arrangement provides conditions for using a high number of segments for the rechargeable energy storage system, which can increase the energy storage capacity of the rechargeable energy storage system, without exceeding limitations on Y-capacitance and electromagnetic interference EMI for example set by charging standards. Moreover, the control arrangement provides conditions for increasing the capability to run several electric components without exceeding limitations on Y-capacitance and electromagnetic interference EMI.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the invention, the object is achieved by a vehicle comprising:
an electric propulsion system for providing motive power to the vehicle,
a rechargeable energy storage system configured to provide electricity to the electric propulsion system during operation of the vehicle,
a number of electric components,
an electrical connector for the connection to an external electric power source, and
a control arrangement,
   wherein the control arrangement is configured to:
charge a first set of segments of the rechargeable energy storage system using electricity from the external electric power source, and
connect a second set of segments of the rechargeable energy storage system to at least one electric component, wherein the second set of segments of the rechargeable energy storage system is separate from the first set of segments.

Since the vehicle comprises a control arrangement according to some embodiments, conditions are provided for charging the rechargeable energy storage system of the vehicle while operating the at least one electric component of the vehicle without exceeding limitations on Y-capacitance and electromagnetic interference EMI for example set by charging standards.

This is because the electromagnetic interference EMI is reduced by only charging the first set of segments of the rechargeable energy storage system while the second set of segments can be used to power the at least one electric component. That is, the electromagnetic interference EMI can be reduced since the at least one electric component can be powered separately from the external electric power source and the external electric power source will thereby not be exposed to the electromagnetic interference EMI from the powering of the least one electric component. Moreover, the electromagnetic interference EMI can be reduced because only the first set of segments of the rechargeable energy storage system is charged using electricity from the external electric power source.

As a further result, a vehicle is provided having conditions for a number of additional segments being added to the rechargeable energy storage system of the vehicle without exceeding limitations on Y-capacitance and electromagnetic interference EMI. In other words, the control arrangement of the vehicle provides conditions for using a high number of segments for the rechargeable energy storage system, which can increase the energy storage capacity of the rechargeable energy storage system of the vehicle, without exceeding limitations on Y-capacitance and electromagnetic interference EMI for example set by charging standards. Moreover, the control arrangement of the vehicle provides conditions for increasing the capability to run several electric components without exceeding limitations on Y-capacitance and electromagnetic interference EMI.

Accordingly, a vehicle is provided overcoming, or at least alleviating, at least some of the above-mentioned problems and drawbacks. As a result, the above-mentioned object is achieved.

Optionally, the vehicle is a heavy road vehicle. Thereby, a heavy road vehicle is provided having conditions for charging the rechargeable energy storage system thereof while operating the at least one electric component of the vehicle without exceeding limitations on Y-capacitance and electromagnetic interference EMI. Moreover, a heavy road vehicle is provided having conditions for a high number of segments for the rechargeable energy storage system thereof, without exceeding limitations on Y-capacitance and electromagnetic interference EMI for example set by charging standards.

Optionally, the rechargeable energy storage system comprises two or more segments each comprising a number of rechargeable battery cells. Thereby, a simple, efficient, and reliable rechargeable energy storage system is provided having conditions for being charged while operating the at least one electric component of the vehicle without exceeding limitations on Y-capacitance and electromagnetic interference EMI for example set by charging standards.

Optionally, the number of electric components comprises one or more of an electric power take-off unit, a climatization component, an air compressor, a servo pump, an inverter, a DC/DC converter, and an electric machine. Thereby, conditions are provided for operating one or more of such electric components using electricity from the second set of segments while charging the first set of segments without exceeding limitations on Y-capacitance and electromagnetic interference EMI for example set by charging standards.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments,

FIG. 2 schematically illustrates an electric propulsion system and a high voltage electrical system of the vehicle illustrated in FIG. 1,

FIG. 3 schematically illustrates the electric propulsion system and the high voltage electrical system of the vehicle illustrated in FIG. 2 after a first time period has elapsed,

FIG. 4 schematically illustrates a method of managing the supply of electrical energy in a vehicle, and

FIG. 5 illustrates a computer-readable medium.

### DETAILED DESCRIPTION

Aspects of the present invention will now be described more fully. Like numbers refer to like elements throughout. Well-known functions or constructions will not necessarily be described in detail for brevity and/or clarity.

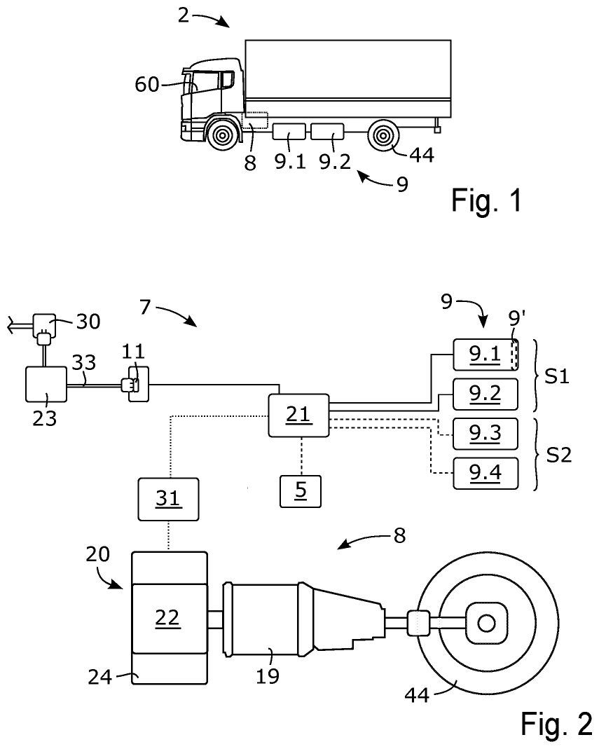

FIG. 1 schematically illustrates a vehicle 2 according to some embodiments. According to the illustrated embodiments, the vehicle 2 is a truck, i.e., a type of heavy road vehicle. According to further embodiments, the vehicle 2, as referred to herein, may be another type of manned or unmanned vehicle for land-based propulsion such as a lorry, a bus, a construction vehicle, a tractor, a car, or the like.

The vehicle 2 comprises an electric propulsion system 8 configured to provide motive power to the vehicle 2. According to the illustrated embodiments, the electric propulsion system 8 is configured to provide motive power to the vehicle 2 via wheels 44 of the vehicle 2. The vehicle 2 further comprises a rechargeable energy storage system 9 configured to provide electricity to the electric propulsion system 8 during operation of the vehicle 2.

FIG. 2 schematically illustrates the electric propulsion system 8 and a high voltage electrical system 7 of the vehicle 2 illustrated in FIG. 1. Below, simultaneous reference is made to FIG. 1 and FIG. 2, if not indicated otherwise.

The rechargeable energy storage system 9 of the vehicle 2 is configured to store electric energy in a rechargeable manner. According to the illustrated embodiments, the rechargeable energy storage system 9 of the vehicle 2 comprises four segments 9.1, 9.2, 9.3, 9.4. In some places herein, the reference sign for the segments 9.1, 9.2, 9.3, 9.4 of the rechargeable energy storage system 9 is abbreviated “9.1-9.4”. In FIG. 1, only two segments 9.1, 9.2 of the rechargeable energy storage system 9 of the vehicle 2 are visible.

The rechargeable energy storage system 9 may comprise another number of segments 9.1-9.4 than four, such as for example a number between two and thirty, or a number between two and twelve. According to embodiments herein, the segments 9.1-9.4 of the rechargeable energy storage system 9 are, or can be, coupled in parallel to the electric propulsion system 8 when the rechargeable energy storage system 9 is supplying electricity to electric propulsion system 8 during travel of the vehicle 2.

According to the illustrated embodiments, each segment 9.1-9.4 of the rechargeable energy storage system 9 comprises one propulsion battery pack only. The propulsion battery pack may comprise a number of propulsion battery modules each comprising a number of rechargeable battery cells 9′, such as lithium-ion battery cells, lithium polymer batteries cells, nickel-metal hydride battery cells, or the like. For reasons of brevity and clarity, only a rechargeable battery cell 9′ of a first segment 9.1 of the number of segments 9.1-9.4 of the rechargeable energy storage system 9 is indicated in FIG. 2.

According to further embodiments, each segment 9.1-9.4 of the rechargeable energy storage system 9 may comprise another number of propulsion battery packs. Moreover, according to further embodiments, each segment 9.1-9.4 of the rechargeable energy storage system 9 may comprise a number of rechargeable battery cells 9′, and/or a number of battery modules each comprising a number of rechargeable battery cells 9′. The rechargeable energy storage system 9 of the vehicle 2 can be said to be comprised in the high voltage electrical system 7 of the vehicle 2.

According to the illustrated embodiments, the electric propulsion system 8 comprises an electric propulsion motor 20. The electric propulsion motor 20 of the electric propulsion system 8 is configured to provide motive power to the vehicle 2 via wheels 44 of the vehicle 2. The electric propulsion motor 20 may also be referred to as an electric propulsion machine, or the like.

According to the illustrated embodiments, the electric propulsion system 8 is a pure electric propulsion system and comprises no internal combustion engine. According to further embodiments, the electric propulsion system 8, as referred to herein, may be a so-called hybrid electric propulsion system comprising an internal combustion engine in addition to the electric propulsion motor 20 for providing motive power to the vehicle 2.

In FIG. 2, the electric propulsion system 8 is illustrated as comprising one electric propulsion motor 20. However, the electric propulsion system 8 may comprise more than one electric propulsion motor 20. According to the illustrated embodiments, the electric propulsion system 8 comprises a transmission 19. The transmission 19 is configured to transmit power between the electric propulsion motor 20 and one or more wheels 44 of the vehicle 2.

The electric propulsion motor 20 comprises a rotor 22 and a stator 24. The electric propulsion motor 20 is capable of converting electrical energy into mechanical energy in the form of rotation of the rotor 22. Moreover, the electric propulsion motor 20 may be capable of converting mechanical energy in the form of rotation of the rotor 22 into electrical energy which for example can be stored in the rechargeable energy storage system 9. In this manner the electric propulsion motor 20 may provide regenerative braking of the vehicle 2.

According to the illustrated embodiments, the electric propulsion system 8 comprises a power module 31 comprising power electronics. The power module 31 is configured to control the amount of electricity supplied from the rechargeable energy storage system 9 to the electric propulsion motor 20.

One of the stator 24 and the rotor 22 may comprise a number of permanent magnets and the other of the stator 24 and the rotor 22 may comprise wire windings. An alternating electric current passed through the wire windings by the power module 31 may cause a torque to be applied to the rotor 22 due to the magnetic interaction between the wire windings and the permanent magnets. During operation of the electric propulsion system 8, the electric current passed through the wire windings may be alternated in a manner following the rotation of the rotor 22. In this manner, a continuous torque can be applied to the rotor 22 during rotation thereof.

The vehicle 2 comprises a number of electric components 5. As understood from the above described, the high voltage electrical system 7 is configured to provide electricity to the electric propulsion system 8 and to a number of electric components 5 during operation of the vehicle 2. That is, in more detail, the high voltage electrical system 7 is configured to provide electricity from the rechargeable energy storage system 9 to the electric propulsion system 8 and to the number of electric components 5 during travel of the vehicle 2.

According to embodiments herein, the high voltage electrical system 7 has a nominal voltage within the so-called Voltage Class B, usually abbreviated VCB, namely a nominal voltage equal to, or higher than, 60 volts. Therefore, the high voltage electrical system 7 may also be referred to as a VCB electrical system of the vehicle 2. Likewise, the number of electric components 5 may also be referred to as a number of VCB components or a number of high voltage electric components.

According to the illustrated embodiments, the vehicle 2 is illustrated as comprising one electric component 5. However, the vehicle 2 may comprise significantly more electric components 5. The number of electric components 5 may for example comprise one or more of an electric power take-off component, a climatization component, an air compressor, a servo pump, an inverter, a DC/DC converter, an electric machine, or the like.

The vehicle 2 may also comprise a low voltage electrical system configured to provide electricity to a number of low voltage vehicle components of the vehicle 2. Moreover, the vehicle 2 may comprise a number of low voltage batteries connected to the low voltage electrical system.

According to embodiments herein, a low voltage electrical system has a nominal voltage within the so-called Voltage Class A, usually abbreviated VCA, namely a nominal voltage lower than 60 volts. Therefore, the low voltage electrical system may also be referred to as a VCA electrical system of the vehicle 2. Likewise, the number of low voltage vehicle components may also be referred to as a number of VCA components.

Purely as examples, the number of low voltage vehicle components may for example comprise one or more of a light emitting component, a driver aid component mounted in a driver environment 60 of the vehicle 2, a climatization component, an air compressor, a servo pump, a DC/DC converter, or the like.

The high voltage electrical system 7 of the vehicle 2 further comprises an electrical connector 11 configured to receive electricity from an external electric power source 30, such as an external electric power grid. According to the illustrated embodiments, the electrical connector 11 form part of a charging interface for charging the rechargeable energy storage system 9. In more detail, according to the embodiments illustrated in FIG. 2, the electrical connector 11 is configured to be electrically connected to the external electric power source 30 via a charging module 23 and an electric supply cable 33.

In the embodiments illustrated in FIG. 2, the charging module 23 is an external charging module 23 electrically connected to the external electric power source 30. In other words, according to the embodiments illustrated in FIG. 2, the electrical connector 11 is configured to be electrically connected to, and receive electricity from, the external electric power source 30 via the charging module 23. The charging module 23 may also be referred to as a propulsion battery charger, a propulsion battery charging station, or the like. According to the illustrated embodiments, the charging module 23 is configured to receive an alternating current AC from the external electric power source 30 and is configured to convert the alternating current AC to a direct current DC which is supplied to the electrical connector 11 via the electric supply cable 33.

According to further embodiments, the charging module may be comprised in the electrical system 3 of the vehicle 2. In other words, according to such embodiments, the charging module is comprised in, and is arranged on, the vehicle 2. Also in such embodiments, the electrical connector 11 may form part of a charging interface for charging the rechargeable energy storage system 9. However, in such embodiments, the electrical connector 11 may be arranged on, and/or may be permanently connected to, the charging module. Moreover, in such embodiments, the electrical connector 11 can be connected to an external electric power source 30 using an electric cable. Moreover, in such embodiments, the external electric power source 30 may be configured to supply an alternating current AC, wherein the alternating current AC is supplied to the electrical connector 11 via an electric cable, and wherein the charging module is configured to convert the alternating current AC to a direct current DC.

The high voltage electrical system 7 of the vehicle 2 further comprises a control arrangement 21. As is further explained herein, the control arrangement 21 is configured to manage the supply of electrical energy in the vehicle 2. The control arrangement 21 may also be referred to as a central electric unit.

According to embodiments herein, the control arrangement 21 is configured to charge a first set S1 of segments 9.1, 9.2 of the rechargeable energy storage system 9 using electricity from the external electric power source 30, and is configured to connect a second set S2 of segments 9.3, 9.4 of the rechargeable energy storage system 9 to at least one electric component 5 for allowing operation of the at least one electric component 5 using electricity from the second set S2 of segments 9.3, 9.4 of the rechargeable energy storage system 9. The second set S2 of segments 9.3, 9.4 of the rechargeable energy storage system 9 is separate from, i.e., different from, the first set S1 of segments 9.1, 9.2.

In this manner, conditions are provided for charging the rechargeable energy storage system 9 while operating the at least one electric component 5 without exceeding limitations on Y-capacitance and electromagnetic interference EMI for example set by charging standards.

This is because the electromagnetic interference EMI is reduced by only charging the first set S1 of segments 9.1, 9.2 of the rechargeable energy storage system 9 while the second set S2 of segments 9.3, 9.4 is used to power the at least one electric component 5. The electromagnetic interference EMI can be reduced since the at least one electric component 5 can be powered separately from the external electric power source 30 and the charging module 23. In other words, the charging module 23 will thereby not be exposed to the electromagnetic interference EMI from the powering of the least one electric component 5. Moreover, the electromagnetic interference EMI can be reduced because only the first set S1 of segments 9.1, 9.2 of the rechargeable energy storage system 9 is charged using electricity from the external electric power source 30 and the charging module 23.

As a further result, the control arrangement 21 provides conditions for a large number of segments 9.1-9.4 and an increased energy storage capacity of the rechargeable energy storage system 9, without exceeding limitations on Y-capacitance and electromagnetic interference EMI during charging of the rechargeable energy storage system 9.

Moreover, the control arrangement 21 provides conditions for an increased capability to run several electric components 5 without exceeding electromagnetic interference EMI limits for example set by the charging standards.

The control arrangement 21 may be configured to disconnect the second set S2 of segments 9.3, 9.4 of the rechargeable energy storage system 9 from the external electric power source 30, i.e., from the electrical connector 11, while charging the first set S1 of segments 9.1, 9.2 of the rechargeable energy storage system 9. Likewise, the control arrangement 21 may be configured to disconnect the first set S1 of segments 9.1, 9.2 from the at least one electric component 5 while charging the first set S1 of segments 9.1, 9.2 of the rechargeable energy storage system 9.

In FIG. 2 the full lines between the electrical connector 11, the control arrangement 21 and the first set S1 of segments 9.1, 9.2 indicates the transfer of electric energy from the electrical connector 11 to the first set S1 of segments 9.1, 9.2. Moreover, the dashed lines between second set S2 of segments 9.3, 9.4, the control arrangement 21, and the at least one electric component 5 indicates the potential transfer of electric energy from the second set S2 of segments 9.3, 9.4 to the at least one electric component 5. The dotted lines between the control arrangement 21, the power module 31, and the electric propulsion motor 20 indicates that no electricity is supplied from the segments 9.1-9.4 to the electric propulsion motor 20 during charging of the rechargeable energy storage system 9.

However, according to some embodiments, some portions of the electric propulsion system 8, such as the electric propulsion motor 20, may be operated during charging of the rechargeable energy storage system 9. According to such embodiments, the transmission 19, or another type of device, such as a clutch, may be utilized to disconnect the rotor 22 of the electric propulsion motor 20 from driven wheels 44 of the vehicle 2, and instead utilizing the electric propulsion motor 20 for another type of power take out.

The control arrangement 21 of the vehicle 2 may comprise a number of connection devices, such as a number of contactors, power electronic switches, or the like, capable of connecting and disconnecting different segments 9.1-9.4 of the rechargeable energy storage system 9 to and from different parts of the high voltage electrical system 7, such as to and from the electrical connector 11 and to and from the at least one electric component 5 of the high voltage electrical system 7 of the vehicle 2.

According to the schematic example illustrated in FIG. 2, the segments 9.1-9.4 of the rechargeable energy storage system 9 are divided into the first set S1 of segments 9.1, 9.2 and the second set S2 of segments 9.3, 9.4 such that each of the first and second sets S1, S2 of segments 9.1-9.4 comprises two segments 9.1-9.4, i.e., two battery packs according to the illustrated embodiments. Since the rechargeable energy storage system 9 according to the illustrated embodiments comprises four segments 9.1-9.4 in total, each of the first and second sets S1, S2 of segments 9.1-9.4 comprises 50% of the total number of segments 9.1-9.4 of the rechargeable energy storage system 9.

However, as mentioned, the rechargeable energy storage system 9 may comprise another number of segments 9.1-9.4, such as a number between two and thirty, or a number between two and twelve. Moreover, the segments 9.1-9.4 of the rechargeable energy storage system 9 may be divided into the first and second sets S1, S2 of segments 9.1-9.4 such that one or both of the first and second sets S1, S2 of segments 9.1-9.4 comprises a different proportion than 50% of the total number of segments 9.1-9.4 of the rechargeable energy storage system 9.

As an example, the first set S1 of segments, as referred to herein, may comprise one or more of the segments 9.1-9.4 of the rechargeable energy storage system 9 and the second set S2 of segments 9.3, 9.4, as referred to herein, may comprise one or more of the other segments 9.1-9.4 of the rechargeable energy storage system 9. Thus, the sum of the first and second sets S1, S2 of segments, as referred to herein, may be lower than the total number of segments 9.1-9.4 of the rechargeable energy storage system 9.

According to some embodiments, the control arrangement 21 may be configured to determine a state of charge level of different segments 9.1-9.4 of rechargeable energy storage system 9 prior to initiating the charging of the first set S1 of segments 9.1, 9.2 using electricity from the external electric power source 30 and prior to connecting the second set S2 of segments 9.3, 9.4 to the at least one electric component 5.

Moreover, the control arrangement 21 may be configured to set the first and second sets S1, S2 of segments 9.1-9.4 to comprise different segments 9.1-9.4 of the rechargeable energy storage system 9 based on the determined state of charge level of the different segments 9.1-9.4 of the rechargeable energy storage system 9. Furthermore, according to some embodiments, the control arrangement 21 may be configured to determine and/or monitor other properties of the different segments 9.1-9.4 of rechargeable energy storage system 9, such as a voltage level and/or a temperature of the different segments 9.1-9.4, and may be configured to set the first and second sets S1, S2 of segments 9.1-9.4 to comprise different segments 9.1-9.4 of the rechargeable energy storage system 9 based on the determined and/or monitored properties.

According to some embodiments, the control arrangement 21 may be configured to set the first and second sets S1, S2 of segments 9.1-9.4 such that the first set S1 of segments 9.1, 9.2 comprises one or more segments 9.1, 9.2 each having a lower state of charge level than segments 9.3, 9.4 comprised in the second set S2 of segments 9.3, 9.4. In this manner, conditions are provided for an efficient utilization of the segments 9.1-9.4 of the rechargeable energy storage system 9 while it can be ensured that the segments 9.1, 9.2 having a lower state of charge level are charged at least initially.

According to some embodiments, the control arrangement 21 may be configured to charge the first set S1 of segments 9.1, 9.2 of the rechargeable energy storage system 9, and maintain the electrical connection between the second set S2 of segments 9.3, 9.4 and the at least one electric component 5 during a first time period. At the end of the first time period, the control arrangement 21 may be configured to perform a switch such that the second set S2 of segments 9.3, 9.4 of the rechargeable energy storage system 9 is charged using electricity from the external electric power source 30 and such that the first set S1 of segments 9.1, 9.2 of the rechargeable energy storage system 9 is connected to the at least one electric component 5 for allowing operation of the at least one electric component 5 using electricity from the first set S1 of segments 9.1, 9.2 of the rechargeable energy storage system 9. In this manner, it can be ensured that the full rechargeable energy storage system 9 can be charged to a desired state of charge level without exceeding limitations on Y-capacitance and electromagnetic interference EMI for example set by charging standards, while providing conditions for operating the at least one electric component 5 using electricity from the rechargeable energy storage system 9 during charging thereof.

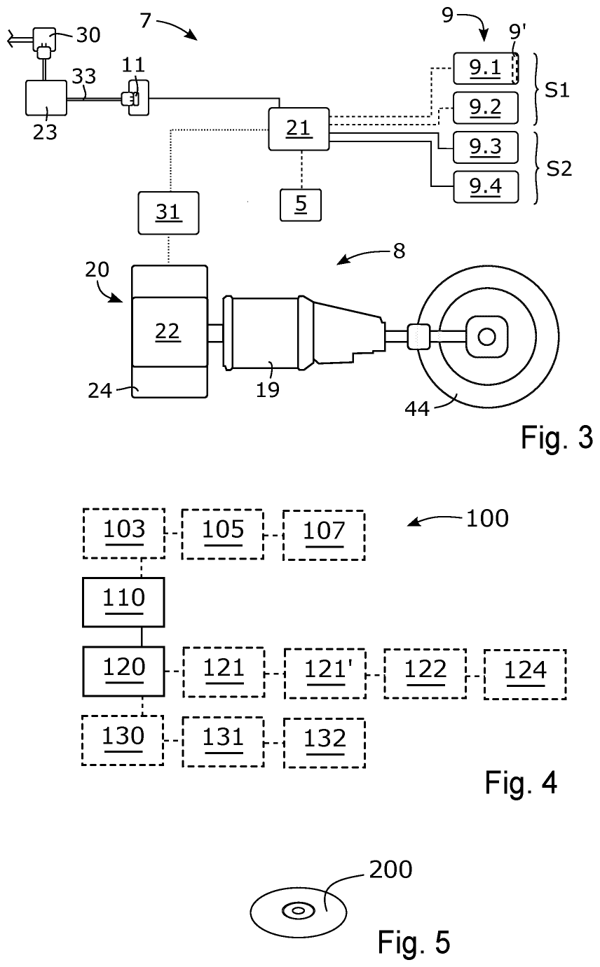

FIG. 3 schematically illustrates the electric propulsion system 8 and the high voltage electrical system 7 of the vehicle 2 illustrated in FIG. 2 after the first time period has elapsed.

That is, in FIG. 3, the control arrangement 21 has performed the switch such that the second set S2 of segments 9.3, 9.4 of the rechargeable energy storage system 9 is charged using electricity from the external electric power source 30 and such that the first set S1 of segments 9.1, 9.2 of the rechargeable energy storage system 9 is connected to the at least one electric component 5 for allowing operation of the at least one electric component 5 using electricity from the first set S1 of segments 9.1, 9.2 of the rechargeable energy storage system 9.

Below, simultaneous reference is made to FIG. 1-FIG. 3, if not indicated otherwise. In FIG. 3 the full lines between the electrical connector 11, the control arrangement 21 and the second set S2 of segments 9.3, 9.4 indicates the transfer of electric energy from the electrical connector 11 to the second set S2 of segments 9.3, 9.4. Moreover, the dashed lines between first set S1 of segments 9.1, 9.2, the control arrangement 21, and the at least one electric component 5 indicates the potential transfer of electric energy from the first set S1 of segments 9.1, 9.2 to the at least one electric component 5. The dotted lines between the control arrangement 21, the power module 31, and the electric propulsion motor 20 indicates that no electricity is supplied from the segments 9.1-9.4 to the electric propulsion motor 20 during charging of the rechargeable energy storage system 9.

However, according to some embodiments, as mentioned above, some portions of the electric propulsion system 8, such as the electric propulsion motor 20, may be operated during charging of the rechargeable energy storage system 9. According to such embodiments, the transmission 19, or another type of device, such as a clutch, may be utilized to disconnect the rotor 22 of the electric propulsion motor 20 from driven wheels 44 of the vehicle 2, and instead utilizing the electric propulsion motor 20 for another type of power take out.

According to some embodiments, the control arrangement 21 may be configured to monitor data representative of at least one of a state of charge level, a voltage level, and a temperature of at least one of the first and second sets S1, S2 of segments 9.1-9.4 of the rechargeable energy storage system 9 and may be configured to set a duration of the first time period based on the monitored data. As examples, the control arrangement 21 may reduce the duration of first time period, and/or may perform the above mentioned switch, if the monitored data indicates a high state of charge of one or more segments 9.1, 9.2 of the first set S1 of segments 9.1, 9.2, a low state of charge of one or more segments 9.3, 9.4 of the second set S2 of segments 9.3, 9.4, a high voltage of one or more segments 9.1, 9.2 of the first set S1 of segments 9.1, 9.2, a low voltage of one or more segments 9.3, 9.4 of the second set S2 of segments 9.3, 9.4, or a high temperature of one or more segments 9.1-9.4 of one of the first and second set S1, S2 of segments 9.1-9.4.

The control arrangement 21 may be configured to charge the second set S2 of segments 9.3, 9.4 of the rechargeable energy storage system 9 using electricity from the external electric power source 30 and may maintain the electrical connection between the first set S1 of segments 9.1, 9.2 of the rechargeable energy storage system 9 and the at least one electric component 5 during a second time period. Moreover, the control arrangement 21 may be configured to monitor data representative of at least one of a state of charge level, a voltage level, and a temperature of at least one of the first and second sets S1, S2 of segments 9.1-9.4 of the rechargeable energy storage system 9 and may be configured to set a duration of the second time period based on the monitored data. The control arrangement 21 may be configured to set the duration of the second time period in the same manner as described for the setting of the first time period above.

Due to these features, it can be ensured that the full rechargeable energy storage system 9, i.e., all segments 9.1-9.4 of the rechargeable energy storage system 9, can be charged to a desired state of charge level while being capable of operating the at least one electric component 5 of the vehicle 2 using electricity from the rechargeable energy storage system 9, without exceeding limitations on Y-capacitance and electromagnetic interference EMI.

FIG. 4 schematically illustrates a method 100 of managing the supply of electrical energy in a vehicle. The vehicle may be a vehicle 2 according to the embodiments illustrated in FIG. 1. Moreover, the vehicle 2 may comprise an electrical system 3 according to the embodiments illustrated in FIG. 2 and FIG. 3. Therefore, below, simultaneous reference is made to FIG. 1-FIG. 4, if not indicated otherwise.

The method 100 is a method of managing the supply of electrical energy in a vehicle 2, wherein the vehicle 2 comprises:
an electric propulsion system 8 for providing motive power to the vehicle 2,
a rechargeable energy storage system 9 configured to provide electricity to the electric propulsion system 8 during operation of the vehicle 2,
a number of electric components 5, and
an electrical connector 11 for the connection to an external electric power source 30, wherein the method 100 comprises the steps of:
charging 110 a first set S1 of segments 9.1, 9.2 of the rechargeable energy storage system 9 using electricity from the external electric power source 30, and
connecting 120 a second set S2 of segments 9.3, 9.4 of the rechargeable energy storage system 9 to at least one electric component 5 of the number of electric components 5, wherein the second set S2 of segments 9.3, 9.4 of the rechargeable energy storage system 9 is separate from the first set S1 of segments 9.1, 9.2.

As illustrated in FIG. 4, the method 100 may comprise the step of:
operating 121 the at least one electric component 5 using electricity from the second set S2 of segments 9.3, 9.4 of the rechargeable energy storage system 9.

Moreover, as is illustrated in FIG. 4, the method 100 may comprise the step of:
disconnecting 121′ the second set S2 of segments 9.3, 9.4 of the rechargeable energy storage system 9 from the external electric power source 30 while charging the first set S1 of segments 9.1, 9.2 of the rechargeable energy storage system 9.

According to some embodiments, the step of charging 110 the first set S1 of segments 9.1, 9.2 of the rechargeable energy storage system 9 is performed during a first time period, and wherein the method 100 comprises the step of, at the end of the first time period:
performing 130 a switch such that the second set S2 of segments 9.3, 9.4 of the rechargeable energy storage system 9 is charged using electricity from the external electric power source 30 and such that the first set S1 of segments 9.1, 9.2 of the rechargeable energy storage system 9 is connected to the at least one electric component 5.

Accordingly, as is illustrated in FIG. 4, the method 100 may comprise the steps of, at the end of the first time period:
charging 131 the second set S2 of segments 9.3, 9.4 of the rechargeable energy storage system 9 using electricity from the external electric power source 30, and
connecting 132 the first set S1 of segments 9.1, 9.2 of the rechargeable energy storage system 9 to at least one electric component 5 of the number of electric components 5.

As illustrated in FIG. 4, the method 100 may comprise the step of:
monitoring 122 data representative of at least one of a state of charge level, a voltage level, and a temperature of at least one of the first and second sets S1, S2 of segments 9.1-9.4 of the rechargeable energy storage system 9, and
setting 124 a duration of the first time period based on the monitored data.

According to some embodiments, the method 100 comprises the steps of, prior to the step of charging 110 the first set S1 of segments 9.1, 9.2 using electricity from the external electric power source 30 and the step of connecting 120 the second set S2 of segments 9.3, 9.4 to the at least one electric component 5:
determining 103 a state of charge level of different segments 9.1-9.4 of rechargeable energy storage system 9, and
setting 105 the first and second sets S1, S2 of segments 9.1-9.4 to comprise different segments 9.1-9.4 of the rechargeable energy storage system 9 based on the determined state of charge level of the different segments 9.1-9.4 of the rechargeable energy storage system 9.

As illustrated in FIG. 4, the step of setting 105 the first and second sets S1, S2 of segments 9.1-9.4 may comprise the step of:
setting 107 the first and second sets S1, S2 of segments 9.1-9.4 such that the first set S1 of segments 9.1, 9.2 comprises one or more segments 9.1, 9.2 each having a lower state of charge level than segments 9.3, 9.4 comprised in the second set S2 of segments 9.3, 9.4.

It will be appreciated that the various embodiments described for the method 100 are all combinable with the control arrangement 21 as described herein. That is, the control arrangement 21 may be configured to perform any one of the method steps 103, 105, 107, 110, 120, 121, 121′, 122, 124, 130, 131, and 132 of the method 100.

FIG. 5 illustrates a computer-readable medium 200 comprising instructions which, when executed by a computer, cause the computer to carry out the method 100 according to some embodiments.

According to some embodiments, the computer-readable medium 200 comprises a computer program comprising instructions which, when the program is executed by a computer, cause the computer to carry out the method 100 according to some embodiments. Below, simultaneous reference is made to FIG. 1-FIG. 5, if not indicated otherwise.

The control arrangement 21, as referred to herein, may be comprised in the vehicle 2 and may be operably connected to one or more components of the vehicle 2 in order to perform the method 100 illustrated in FIG. 4.

One skilled in the art will appreciate that the method 100 of managing the supply of electrical energy in a vehicle 2 may be implemented by programmed instructions. These programmed instructions are typically constituted by a computer program, which, when it is executed in the control arrangement 21, ensures that the control arrangement 21 carries out the desired control, such as the method steps 103, 105, 107, 110, 120, 121, 121′, 122, 124, 130, 131, and 132 described herein. The computer program is usually part of a computer program product 200 which comprises a suitable digital storage medium on which the computer program is stored.

The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

The control arrangement 21 may be connected to components of the vehicle 2 for receiving and/or sending input and output signals. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the vehicle's control system and/or the component or components for which the signals are intended. Each of the connections for receiving and sending input and output signals may take the form of one or more from among a cable, a data bus, e.g., a CAN (controller area network) bus, a MOST (media orientated systems transport) bus or some other bus configuration, or a wireless connection.

In the embodiments illustrated, the vehicle 2 comprises a control arrangement 21 but might alternatively be implemented wholly or partly in two or more control arrangements or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles of the type here concerned are therefore often provided with significantly more control arrangements than depicted in FIG. 2 and FIG. 3, as one skilled in the art will surely appreciate.

The computer program product 200 may be provided for instance in the form of a data carrier carrying computer program code for performing at least some of the method steps 103, 105, 107, 110, 120, 121, 121′, 122, 124, 130, 131, and 132 according to some embodiments when being loaded into one or more calculation units of the control arrangement 21. The data carrier may be, e.g. a CD ROM disc, as is illustrated in FIG. 5, or a ROM (read-only memory), a PROM (programmable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

The segments 9.1-9.4 of the rechargeable energy storage system 9, as referred to herein, may also be referred to as sections of the rechargeable energy storage system 9. Accordingly, the first and second sets S1, S2 of segments 9.1-9.4 of the rechargeable energy storage system 9 may also be referred to as a respective first and second sets S1, S2 of sections of the rechargeable energy storage system 9.

Moreover, the first and second sets S1, S2 of segments 9.1-9.4 of the rechargeable energy storage system 9 may also be referred to as a respective first and second portion of the rechargeable energy storage system 9.

1. A method of managing the supply of electrical energy in a vehicle, wherein the vehicle comprises:
an electric propulsion system for providing motive power to the vehicle;
a rechargeable energy storage system configured to provide electricity to the electric propulsion system during operation of the vehicle;
a number of electric components; and
an electrical connector for the connection to an external electric power source,
wherein the method comprises the steps of:
charging a first set of segments of the rechargeable energy storage system using electricity from the external electric power source; and
connecting a second set of segments of the rechargeable energy storage system to at least one electric component, wherein the second set of segments of the rechargeable energy storage system is separate from the first set of segments.

2. The method according to claim 1, wherein the step of charging the first set of segments of the rechargeable energy storage system is performed during a first time period, and wherein the method comprises the step of, at the end of the first time period:
performing a switch such that the second set of segments of the rechargeable energy storage system is charged using electricity from the external electric power source and such that the first set of segments of the rechargeable energy storage system is connected to the at least one electric component.

3. The method according to claim 2, wherein the method comprises the step of:
monitoring data representative of at least one of a state of charge level, a voltage level, and a temperature of at least one of the first and second sets of segments of the rechargeable energy storage system; and
setting a duration of the first time period based on the monitored data.

4. The method according to claim 1, further comprises the steps of, prior to the step of charging the first set of segments using electricity from the external electric power source and the step of connecting the second set of segments to the at least one electric component:
determining a state of charge level of different segments of rechargeable energy storage system; and
setting the first and second sets of segments to comprise different segments of the rechargeable energy storage system based on the determined state of charge level of the different segments of the rechargeable energy storage system.

5. The method according to claim 4, wherein the step of setting the first and second sets of segments comprises the step of:
setting the first and second sets of segments such that the first set of segments comprises one or more segments each having a lower state of charge level than segments comprised in the second set of segments.

6. A computer program product stored on a non-transitory computer-readable medium, said computer program product for managing the supply of electrical energy in a vehicle, wherein the vehicle comprises: an electric propulsion system for providing motive power to the vehicle; a rechargeable energy storage system configured to provide electricity to the electric propulsion system during operation of the vehicle; a number of electric components; and an electrical connector for the connection to an external electric power source, wherein said computer program product comprising computer instructions to cause one or more computing devices to perform the following operations:
charging a first set of segments of the rechargeable energy storage system using electricity from the external electric power source; and
connecting a second set of segments of the rechargeable energy storage system to at least one electric component, wherein the second set of segments of the rechargeable energy storage system is separate from the first set of segments.

7. (canceled)

8. A control arrangement configured to manage the supply of electrical energy in a vehicle, wherein the vehicle comprises:
an electric propulsion system for providing motive power to the vehicle;
a rechargeable energy storage system configured to provide electricity to the electric propulsion system during operation of the vehicle;
a number of electric components; and
an electrical connector for the connection to an external electric power source,
wherein the control arrangement is configured to perform the operations of:
charge a first set of segments of the rechargeable energy storage system using electricity from the external electric power source; and
connect a second set of segments of the rechargeable energy storage system to at least one electric component, wherein the second set of segments of the rechargeable energy storage system is separate from the first set of segments.

9. A vehicle comprising:
an electric propulsion system for providing motive power to the vehicle;
a rechargeable energy storage system configured to provide electricity to the electric propulsion system during operation of the vehicle;
a number of electric components;
an electrical connector for the connection to an external electric power source; and
a control arrangement configured to:
charging a first set of segments of the rechargeable energy storage system using electricity from the external electric power source; and
connecting a second set of segments of the rechargeable energy storage system to at least one electric component, wherein the second set of segments of the rechargeable energy storage system is separate from the first set of segments.

10. The vehicle according to claim, wherein the vehicle is a heavy road vehicle.

11. The vehicle according to claim 9, wherein the rechargeable energy storage system comprises two or more segments each comprising a number of rechargeable battery cells.

12. The vehicle according to claim 9, wherein the number of electric components comprises one or more of:
an electric power take-off unit;
a climatization component;
an air compressor;
a servo pump;
a DC/DC converter; and
an electric machine.

13. The control arrangement according to claim 8, wherein the control arrangement performs the operations based on computer instructions stored on a non-transitory computer-readable medium.
